(19) United States
(12) Patent Application Publication
(10) Pub. No.: US 2024/0307800 A1
(43) Pub. Date: Sep. 19, 2024

(54) FILTER CARTRIDGE FOR INSERTION IN A FILTER HOUSING OF A FLUID FILTER

(71) Applicant: HENGST SE, Muenster (DE)

(72) Inventors: Mark VON LUETZAU, Muenster (DE); Marvin Michael LEE, Muenster (DE); Julian NIEHOFF, Coesfeld (DE); Jens BACHMANN, Muenster (DE)

(21) Appl. No.: 18/281,875

(22) PCT Filed: Mar. 7, 2022
(86) PCT No.: PCT/EP2022/055768

§ 371 Date: Sep. 13, 2023

(30) Foreign Application Priority Data
Mar. 16, 2021 (DE) 102021106331.0

(51) Int. Cl. B01D 35/143; B01D 29/21; B01D 29/60; B01D 35/147; B01D 35/16; B01D 35/30; B01D 36/00; H04B 1/04

(52) U.S. Cl. CPC B01D 35/143; B01D 29/21; B01D 29/608; B01D 35/147; B01D 35/16; B01D 35/30; B01D 36/005; B01D 2201/0415; B01D 2201/291; B01D 2201/52; B01D 2201/56; B01D 2201/64; H04B 1/04

(57) ABSTRACT

The invention relates to a filter cartridge for insertion in a filter housing of a fluid filter, comprising: a filter material configured to filter a fluid flowing therethrough from a raw side to a clean side of the fluid filter during operation of the fluid filter; and a filter-cartridge-side radio module configured to move, during operation of the fluid filter, according to the pressure difference between the raw side and the clean side of the fluid filter, which pressure difference depends on the degree of contamination of the filter material, and to communicate, in order to ascertain the degree of contamination of the filter material, with a housing-side radio module of the fluid filter, the distance (A) of which housing-side radio module from the filter-cartridge-side radio module varies upon movement of the filter-cartridge-side radio module.

The invention relates to a filter insert for insertion into a filter housing of a fluid filter, comprising a filter material which is designed to be flowed through by a fluid to be filtered, from a raw side to a clean side of the fluid filter, during operation of the fluid filter.

The invention further relates to a fluid filter for filtering a fluid. The fluid filter comprises a filter housing having a housing-side radio module and a filter cartridge having a filter-cartridge-side radio module, wherein the filter cartridge is designed to be inserted in the filter housing and wherein the filter-cartridge-side radio module and the housing-side radio module are designed to communicate with each other.

Furthermore, the invention relates to a filter system with a fluid filter and an electronic data processing device.

During operation of a fluid filter, due to fluid filtration the filter material of the fluid filter becomes clogged with particles which are filtered out of the fluid flowing through the filter material. The resulting increasing contamination of the filter material leads to an increasing pressure difference between the raw side and the clean side of the fluid filter. Some fluid filter types are equipped with a bypass valve which opens when a differential pressure limit between the raw side and the clean side is exceeded, in order to ensure a required fluid flow through the fluid filter despite a heavily contaminated filter material. By the bypass valve opening, fluid filtration is bypassed so that at least a portion of the fluid can flow through the fluid filter unfiltered.

In practice, filter cartridges should be replaced in good time before a critical contamination state is reached. For detection of the contamination state of the filter material, for example the opening state of the bypass valve can be monitored. In this context, US 2017/0340996 A1 proposes monitoring the opening state of the bypass valve by means of a Hall sensor.

In a large number of applications in which fluid filters are used, for example in the oil or fuel filtration of motor vehicles or in industrial filtration, there is a need for intelligent fluid filters which are able to provide information about the state of contamination that for example allows identification of the filter cartridge used or relates to operating parameters of the fluid filter or filter cartridge. Up to now, this has not been possible with the sensors used to detect the contamination state of the filter material.

The object on which the present invention is based is thus to enable intelligent contamination state detection in a fluid filter, in which information that goes beyond the contamination state is provided for the operation of the fluid filter or the operation of the machine in which the fluid filter is used.

The object is achieved by a filter cartridge of the type mentioned above, wherein the filter cartridge according to the invention has a filter-cartridge-side radio module which is designed to move, during operation of the fluid filter, according to the pressure difference between the raw side and the clean side of the fluid filter, which pressure difference depends on the degree of contamination of the filter material, and in order to ascertain the degree of contamination of the filter material, to communicate with a housing-side radio module of the fluid filter, the distance of which housing-side radio module from the filter-cartridge-side radio module varies upon movement of the filter-cartridge-side radio module.

The movement of the radio module is caused by the pressure difference between the raw side and the clean side of the fluid filter, so that the contamination state is detected via the varying distance between the housing-side radio module and the filter-cartridge-side radio module. In this respect, the filter-cartridge-side radio module enables a radio-based detection of the state of contamination. Furthermore, information going beyond the contamination state can be provided by the filter-cartridge-side radio module, which information can be retrieved by the housing-side radio module. By way of example, the filter-cartridge-side radio module permits a radio-based identification of the filter cartridge by sending a cartridge-specific identifier. The filter-cartridge-side radio module is preferably designed to move in the axial direction as a function of the pressure difference between the raw side and the clean side of the fluid filter during operation of the fluid filter.

The communication between the filter-cartridge-side radio module and the housing-side radio module can take place continuously or discontinuously. The communication between the filter-cartridge-side radio module and the housing-side radio module can take place at regular or at irregular time intervals and/or can be triggered or prompted by specific events. Detection of the contamination state thus also takes place at regular or irregular intervals and/or according to events.

The filter cartridge can also have a plurality of filter-cartridge-side radio modules which are designed to move during operation of the fluid filter and to communicate with a housing-side radio module of the fluid filter in order to detect the contamination state of the filter material as a function of the pressure difference between the raw side and the clean side of the fluid filter. The plurality of filter-cartridge-side radio modules can be radio modules of the same type or radio modules of different types. For example, the radio modules can use different modulation types so that their radio signals can be distinguished. Furthermore, the radio signals can be assigned to a filter-cartridge-side radio module using a transmitted identifier. The plurality of filter-cartridge-side radio modules can use the same transmission frequency or different transmission frequencies. The number of filter cartridge-side radio modules communicating with the housing-side radio module is preferably dependent on their axial position and thus on their distance from the housing-side radio module. Via the number of filter cartridge-side radio modules communicating with the housing-side radio module the distance between the housing-side radio module and the filter-cartridge-side radio modules can thus be ascertained, and from this the contamination state of the filter material can be deduced. The filter-cartridge-side radio modules can be arranged one above the other. When the distance to the housing-side radio module is short, a larger number of filter-cartridge-side radio modules communicates with the housing-side radio module than when the distance to the housing-side radio module is greater.

The fluid filter can be, for example, a liquid filter, in particular an oil filter or a fuel filter, or an air or gas filter. The fluid can accordingly be a liquid, in particular oil or fuel, or air, a gas or a gas mixture.

The filter material can form a circumferential filter material body. The filter material can be folded several times and/or be designed as a bellows.

In a preferred embodiment of the filter cartridge according to the invention, the filter-cartridge-side radio module is designed to transmit one or more radio signals by means of which the distance of the filter-cartridge-side radio module from the housing-side radio module can be determined and/or which allows an identification of the filter cartridge or a type recognition of the filter cartridge. By way of example, the filter-cartridge-side radio module is designed to transmit a uniquely assigned and/or filter-cartridge-specific identifier, so that the filter cartridge located in the filter housing can be identified via a signal evaluation. The one or more radio signals can also be used to transmit filter-cartridge-related operating information, such as the operational performance or the operating time so far, to the housing-side radio module. Furthermore, fluid-related operating information can be transmitted from the filter-cartridge-side radio module to the housing-side radio module, for example the current temperature of the fluid or a past temperature development of the fluid. This filter-cartridge-related and/or fluid-related operating information can be determined and recorded by the filter-cartridge-side radio module during operation. The filter-cartridge-side radio module can consequently comprise a memory for storing the filter-cartridge-related and/or fluid-related operating information, which is written during operation with the filter-cartridge-related and/or fluid-related operating information.

In a further development, the filter cartridge according to the invention has a bypass valve or at least a part of a bypass valve, wherein the filter-cartridge-side radio module is arranged on the bypass valve or on the filter-cartridge-side part of the bypass valve or is integrated into the bypass valve or the filter-cartridge-side part of the bypass valve. During operation of the fluid filter, the bypass valve is arranged between the raw side and the clean side of the fluid filter. The bypass valve comprises at least one part that moves during operation of the fluid filter as a function of the pressure difference between the raw side and clean side of the fluid filter, which difference depends on the contamination state of the fluid filter. The filter-cartridge-side radio module can therefore be arranged on this movable part of the bypass valve in order to detect the contamination state of the fluid filter via the position of the filter-cartridge-side radio module and thus the distance from the housing-side radio module.

In another preferred embodiment of the filter cartridge according to the invention, the bypass valve has a movable closure body or the filter-cartridge-side part of the bypass valve is a movable closure body. The movable closure body is designed to move as a function of the pressure difference between the raw side and the clean side of the fluid filter relative to a contact body, bearing a valve seat, of the bypass valve. The closure body is the part of the bypass valve which executes the movement leading to an opening of the bypass valve. The filter-cartridge-side radio module is arranged on the closure body of the bypass valve and/or is designed to move together with the closure body of the bypass valve. The closure body is preferably a shut-off piston. The closure body of the bypass valve is preferably designed to move in the axial direction according to the pressure difference between the raw side and the clean side of the fluid filter during operation of the fluid filter. The closure body preferably provides a radial seal. The closure body is preferably designed to block a bypass line between the raw side and the clean side until the pressure difference between the raw side and the clean side reaches a differential pressure limit value. When the differential pressure limit value is reached, the closure body then releases the bypass line so that at least a portion of the fluid to be filtered can pass from the raw side to the clean side without flowing through the filter material. The bypass line can be formed by one or more passage openings in a wall surrounding the closure body, which are opened up by an axial movement of the closure body. Below the differential pressure limit value or before the differential pressure limit value is reached, the closure body moves with increasing differential pressure without the bypass line being opened.

In a further preferred embodiment of the filter cartridge according to the invention, the closure body is arranged in a guide sleeve which is designed to guide the closure body during a movement caused by differential pressure. The guide sleeve can be surrounded by the filter material. Furthermore, the guide sleeve can be arranged axially spaced apart from the filter material, for example above or below a front end region of the filter material. Furthermore, the guide sleeve can be an integral component of an end plate arranged at the end face of the filter material.

In another preferred embodiment of the filter cartridge according to the invention, the bypass valve has a movable contact body or the filter cartridge-side part of the bypass valve is a movable contact body. The movable contact body bears a valve seat for a closure body of the bypass valve, wherein the contact body is designed to move relative to the closure body as a function of the pressure difference between the raw side and the clean side of the fluid filter, wherein the filter-cartridge-side radio module is arranged on the contact body of the bypass valve and/or is designed to move together with the contact body of the bypass valve. The contact body bearing the valve seat is the part of the bypass valve which is stationary or does not execute any movement during the opening of the bypass valve. Due to the fact that the filter-cartridge-side radio module is arranged on the contact body of the bypass valve, the contamination state of the filter material can take place via the detection of the distance between the filter-cartridge-side radio module and the housing-side radio module. The contact body of the bypass valve is preferably designed to move in the axial direction as a function of the pressure difference between the raw side and the clean side of the fluid filter during operation of the fluid filter. A bypass line between the raw side and the clean side can be opened by a movement of the contact body, the opening taking place when a differential pressure limit value between the raw side and the clean side is reached. Below the differential pressure limit value or before the differential pressure limit value is reached, the contact body moves with increasing differential pressure without the bypass line being opened.

The filter-cartridge-side radio module can also be fastened to an elastomer bellows of the filter cartridge, wherein the elastomer bellows is deformed with increasing differential pressure between the raw side and the clean side of the fluid filter and permits an axial movement of the filter-cartridge-side radio module.

In another preferred embodiment of the filter cartridge according to the invention, the filter material is supported by a support structure which is designed to move together with the filter material during operation of the fluid filter according to the pressure difference between the raw side and the clean side of the fluid filter, wherein the filter-cartridge-side radio module is arranged on the support structure or the filter material and/or is designed to move together with the support structure and/or the filter material. The support structure can have an upper and/or a lower end plate. The upper end plate is preferably arranged on the upper end face of the filter material. The lower end plate is preferably arranged on the lower end face of the filter material. The support structure can have a support body connecting the end plates. The support body can have a lattice structure. The support structure can be one-piece or multi-piece. The support structure is preferably designed to move in the axial direction during operation of the fluid filter together with the filter material as a function of the pressure difference between the raw side and the clean side of the fluid filter. The filter-cartridge-side radio module can be arranged, for example, centrally on the support structure, in particular centrally on an end plate or centrally on the support structure connecting the end plates to one another.

In addition, a filter cartridge according to the invention is advantageous in which the support structure has a radio module holder which preferably extends in the axial direction from an end disk of the support structure arranged on the end face of the filter material on the side facing away from the filter material, wherein the filter-cartridge-side radio module is held axially spaced apart from the end disk and/or the filter material by the radio module holder. Via the radio module holder, it is possible to arrange the filter-cartridge-side radio module in an area in the vicinity of the housing wall of the filter housing so that the housing-side radio module can be arranged and fastened in the area of the housing wall.

In another preferred embodiment of the filter cartridge according to the invention, the radio module holder has a floating chamber in which a buoyant radio module is arranged. The floating chamber can be a floating cage. The floating chamber is preferably designed to project into a water collection area, in which water, in particular water separated from the fluid to be filtered, collects during operation of the fluid filter. In this respect, the buoyant radio module can be used to detect the water level in the water collection area of the fluid filter. A change in fill level in the water collection area causes a movement of the buoyant radio module located in the floating chamber. The water level in the water collection area can thus also be deduced via the position of the buoyant radio module.

The filter material is preferably designed to separate water from the fluid during operation of the fluid filter. The buoyant radio module is preferably designed to float on a water quantity separated from the fluid during operation of the fluid filter.

In another preferred embodiment of the filter cartridge according to the invention, the buoyant radio module is designed to float on the water collecting in the water collection area, wherein the floating chamber preferably has a buoyancy region for the buoyant radio module, which allows the buoyant radio module to rise when the water level rises in the water collection area of the fluid filter. The buoyant radio module preferably has a density lower than water and/or a density less than 997 kg/m³. The buoyant radio module can be designed to float, during operation of the fluid filter, in a boundary layer between the fluid to be filtered on the raw side of the fluid filter and the water quantity present in the water collection area of the fluid filter. The buoyant radio module can have a higher density than gasoline and/or diesel and/or a density of more than 748 kg/m³ or more than 833 kg/m³. Gasoline has a density of 748 kg/m³. Diesel has a density of 833 kg/m³.

The filter cartridge can also include a plurality of buoyant radio modules, or a buoyant radio module having a plurality of radio units, which are designed to float on the quantity of water present in the water collection area of the fluid filter during operation of the fluid filter in order to detect the water level in the water collection area of the fluid filter, and to communicate with a housing-side radio module of the fluid filter. The plurality of buoyant radio modules or the plurality of radio units of the one buoyant radio module can be radio modules or radio units of the same type or radio modules or radio units of different types. The plurality of buoyant radio modules or the plurality of radio units of the one buoyant radio module can use different types of modulation, for example, so that their radio signals are distinguishable. Furthermore, with the aid of a transmitted identifier the radio signals can be assigned to a buoyant radio module or to a radio unit of the one buoyant radio module. The plurality of buoyant radio modules or the plurality of radio units of the one buoyant radio module can use the same transmission frequency or transmission frequencies differing from one another. The number of floating radio modules communicating with the housing-side radio module or the number of radio units of the one buoyant radio module communicating with the housing-side radio module is preferably dependent on their axial position and thus on their distance from the housing-side radio module. Via the number of buoyant radio modules communicating with the housing-side radio module or the number of radio units of the one buoyant radio module communicating with the housing-side radio module, it is thus possible to determine the distance between the housing-side radio module and the buoyant radio modules or the distance between the housing-side radio module and the radio units of the one buoyant radio module, from which the water level in the water collection area can be deduced. The plurality of buoyant radio modules or the plurality of radio units of the one buoyant radio module can be arranged one above the other. When the distance to the housing-side radio module is short, a larger number of buoyant radio modules, or a larger number of radio units of the one buoyant radio module, will communicate with the housing-side radio module than when the distance to the housing-side radio module is greater.

In a development of the filter cartridge according to the invention, the filter-cartridge-side radio module and/or the buoyant radio module are designed to obtain the energy required for communication with the housing-side radio module from an electromagnetic field generated by the housing-side radio module. The filter-cartridge-side radio module and/or the buoyant radio module do not therefore require their own power supply. In this respect, a wiring of the filter-cartridge-side radio module and/or the buoyant radio module can be dispensed with. This ensures less wear and increased reliability against failure. Furthermore, restrictions in the situation of the filter-cartridge-side radio module and the buoyant radio module are removed.

In another preferred embodiment of the filter cartridge according to the invention, the filter-cartridge-side radio module and/or the buoyant radio module is a transponder, in particular an RFID transponder, or the filter-cartridge-side radio module and/or the buoyant radio module each comprise a transponder, in particular an RFID transponder. The housing-side radio module is preferably an RFID reading device or comprises an RFID reading device.

Furthermore, the filter-cartridge-side radio module can be designed to detect or measure the electrical conductivity of the fluid in the vicinity of the filter-cartridge-side radio module. The electrical conductivity of fluids, for example of oil, increases over time due to the ingress of soot and water or abraded metal particles, so that the fluid quality can be determined by measuring the electrical conductivity. In order to measure the electrical conductivity, the filter-cartridge-side radio module could have an open or interrupted electrical line, the state of which is monitored by means of an electronic monitoring device. The electrical conductivity of the fluid and thus the current fluid quality can be determined via a current flow measurement and/or resistance measurement at the open line. These data can be used in a motor vehicle, for example, when monitoring the engine condition. In connection with the use of such a system in oil filtration for an internal combustion engine, the following scenario for example arises. In the case of a high conductivity of the oil and of regular short trips, there will usually be a large quantity of water in the oil, so that the driver can be informed that a long trip should be made soon in order to optimize operational performance. Furthermore, the control system of the motor vehicle can adjust the service interval on the basis of the collected data. In the case of a high conductivity of the oil in combination with long distances traveled and corresponding data from the bus system of the vehicle, it can also be determined, for example, whether there is a leak between the cooling water supply and the oil supply. In this case, the driver of the motor vehicle can be informed that a service or an inspection is required.

In a further preferred embodiment of the filter cartridge according to the invention, the filter-cartridge-side radio module and/or the buoyant radio module has a temperature measuring device and is designed to transmit temperature measurement values to the housing-side radio module. The filter cartridge can be for example a fuel filter cartridge. The housing-side radio module receives, for example, a temperature signal from the filter-cartridge-side radio module and/or the buoyant radio module. The filter-cartridge-side radio module and/or the buoyant radio module can comprise an additional microcontroller and one or more temperature sensors which form the temperature measuring device. The transmitted temperature measurement values can be used for controlling or regulating a heating device, in particular a fuel heating device. If the fuel temperature is too low, the fuel heating device will be switched on. The housing-side radio module can regulate the fuel heating device. The one or more temperature sensors can each have a temperature-dependent resistor, such as a hot conductor (NTC resistor) or a cold conductor (PTC resistor). For the detection of fuel temperatures, the detection range of such sensors suffices, since only comparatively low temperatures below 80° C. need to be detected. Furthermore, it is not necessary to measure constantly, but only at engine start-up and/or at regular or irregular time intervals.

The object underlying the invention is further achieved by a fuel filter of the type mentioned above, wherein the filter cartridge of the fluid filter according to the invention is designed according to any one of the embodiments described above. With regard to the advantages and modifications of the fluid filter according to the invention, reference is accordingly made first to the advantages and modifications of the filter cartridge according to the invention.

In a preferred embodiment of the fluid filter according to the invention, the housing-side radio module is designed to receive one or more radio signals from the filter-cartridge-side radio module, by means of which the distance of the filter-cartridge-side radio module to the housing-side radio module can be determined. Via the determined distance of the filter-cartridge-side radio module from the housing-side radio module, the state of contamination of the filter material of the filter cartridge can then be determined via a relationship between the distance and the contamination state or via a corresponding characteristic map.

In addition, a fluid filter is preferred in which the filter housing has a housing base body and a housing cover, wherein the housing-side radio module is arranged in or on the housing base body or the housing cover. The housing base body and the housing cover can preferably be connected to each other in a non-destructively detachable manner, for example via corresponding threaded sections on the housing base body and the housing cover. The housing cover can be screwable onto the housing base body, for example. For example, the housing cover can have a cup shape. The filter housing of the fluid filter according to the invention can further comprise a supporting mandrel for the filter cartridge, the housing-side radio module being arranged on or in the supporting mandrel.

In a preferred embodiment, the fluid filter according to the invention has a water drainage valve for draining the water which collects in a water collection area of the fluid filter, wherein the water drainage valve is designed to be actuated according to the distance between the buoyant radio module and the housing-side radio module. The fluid filter in this case can be a fuel filter, for example. The water drainage valve can, for example, be opened and/or closed automatically as a function of the water level in the water collection area. For example, when a water fill level limit value is reached or exceeded, the water drainage valve can be opened automatically in order to drain the water from the water collection area or from the fluid filter. The water fill level can be determined, for example by a data processing device of a filter system, via the distance between the buoyant radio module and the housing-side radio module. The water drainage valve can be a solenoid valve. The control of the water drainage valve as a function of the distance between the buoyant radio module and the housing-side radio module is preferably effected via a control device which is a component of a filter system. In addition to the buoyant radio module, the filter cartridge of the fluid filter can have a filter-cartridge-side radio module, which is designed to move during operation of the fluid filter as a function of the pressure difference between the raw side and the clean side of the fluid filter, which pressure difference is dependent on the contamination state of the filter material. However, such a filter-cartridge-side radio module is not absolutely necessary. The filter cartridge of the fluid filter can include a buoyant radio module for controlling the water drainage even without a filter-cartridge-side radio module for detecting the contamination state.

The object underlying the invention is further achieved by a filter system of the type mentioned above, wherein the fluid filter of the filter system according to the invention is designed according to any one of the embodiments described above. The data processing device is preferably designed to evaluate one or more signals transmitted from the filter-cartridge-side radio module to the housing-side radio module and/or to evaluate the signal properties thereof in order to determine the distance between the filter-cartridge-side radio module and the housing-side radio module. For distance detection, the data processing device preferably determines the signal quality of the radio signals received by the housing-side radio module. For this purpose, the housing-side radio module or the data processing device can comprise an amplifier circuit for signal amplification and/or a filter circuit for signal filtering. With regard to the advantages and modifications of the filter system according to the invention, reference is thus first made to the advantages and modifications of the filter system according to the invention.

In a preferred embodiment of the filter system according to the invention, the electronic data processing device is designed to determine the distance between the filter-cartridge-side radio module and the housing-side radio module on the basis of the signal strength and/or the signal noise of the one or more signals. Via the signal strength and the signal noise of the signals transmitted by the filter-cartridge-side radio module to the housing-side radio module, the distance between the filter-cartridge-side radio module and the housing-side radio module can be calculated comparatively precisely via a corresponding signal evaluation. The contamination state of the filter material can then be determined on the basis of this calculation.

In another preferred embodiment of the filter system according to the invention, the electronic data processing device is designed to determine the contamination state of the filter material on the basis of the distance between the filter-cartridge-side radio module and the housing-side radio module. In order to determine the contamination state of the filter material, the electronic data processing device can use an, in particular filter-specific, filter-cartridge-specific or filter-material-specific relationship between the distance of the filter-cartridge-side radio module from the housing-side radio module and the contamination state of the filter material. This relationship can also be a characteristic map, for example. The relationship or the characteristic map can be stored in a memory of the electronic data processing device.

Preferred embodiments of the invention are explained and described in more detail below with reference to the accompanying drawings, in which:

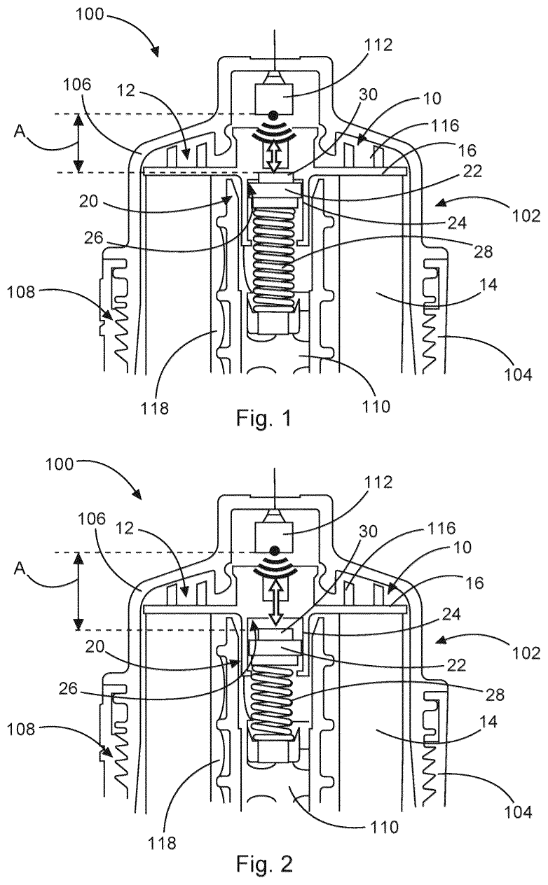

FIG. 1 shows an exemplary embodiment of the fluid filter according to the invention, in which the filter material of the filter cartridge does not have any contamination, in a schematic sectional view;

FIG. 2 shows the fluid filter depicted in FIG. 1, wherein the filter material of the filter cartridge has a slight contamination, in a schematic sectional view;

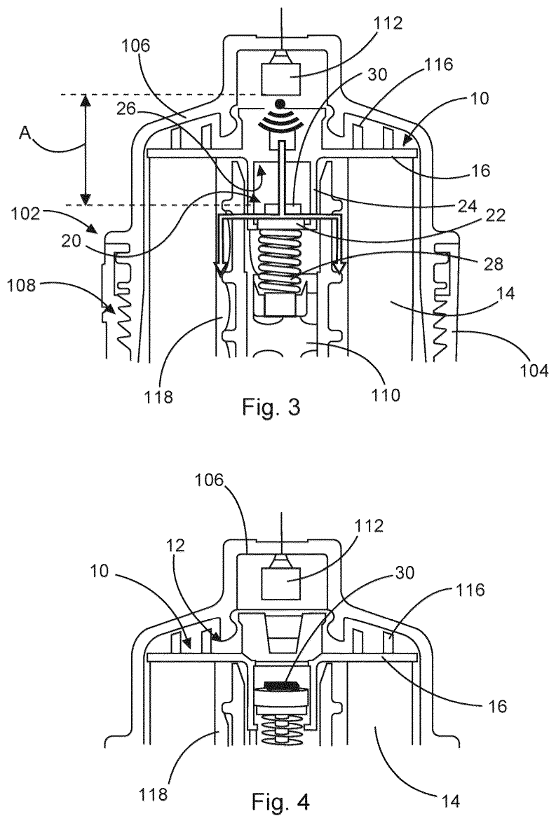

FIG. 3 shows the fluid filter depicted in FIG. 1, wherein the filter material of the filter cartridge has severe contamination, in a schematic sectional view;

FIG. 4 shows a detail view of the fluid filter shown in FIG. 1, in a schematic sectional view;

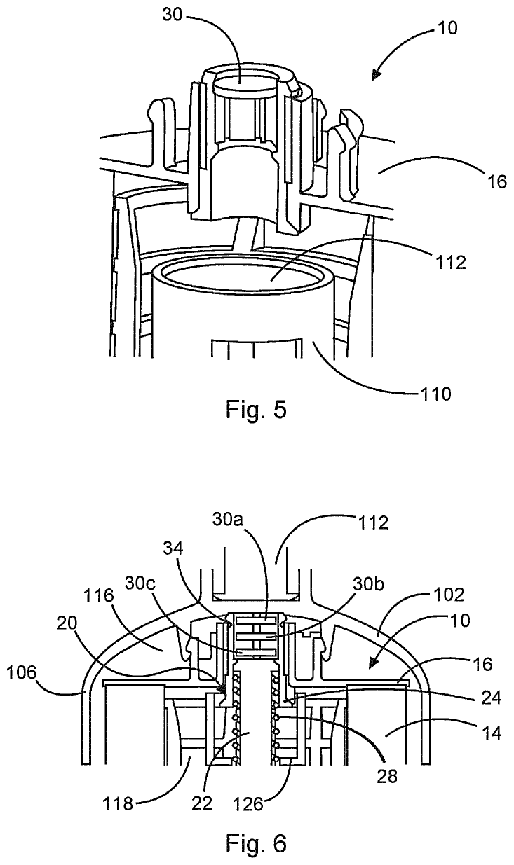

FIG. 5 shows a partial region of a further fluid filter according to the invention, in a perspective sectional view;

FIG. 6 shows a partial region of a further fluid filter according to the invention, in a schematic sectional view;

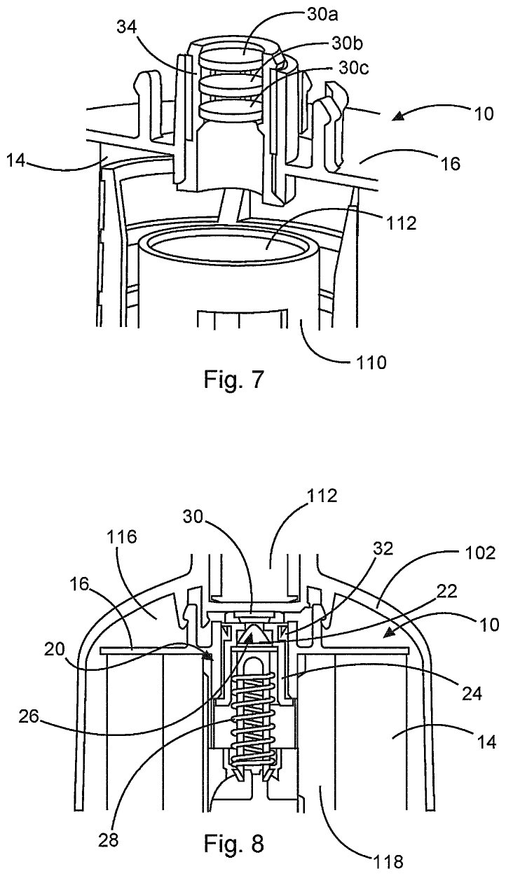

FIG. 7 shows a partial region of a further fluid filter according to the invention, in a perspective sectional view;

FIG. 8 shows a partial region of a further fluid filter according to the invention, in a schematic sectional view;

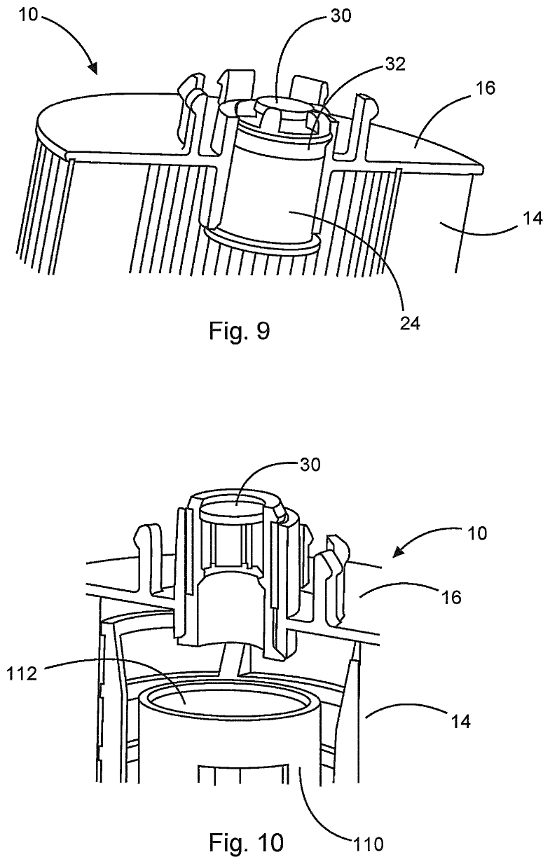

FIG. 9 shows a partial region of a filter insert according to the invention, in a perspective sectional view;

FIG. 10 shows a partial section of a further fluid filter according to the invention, in a schematic sectional view;

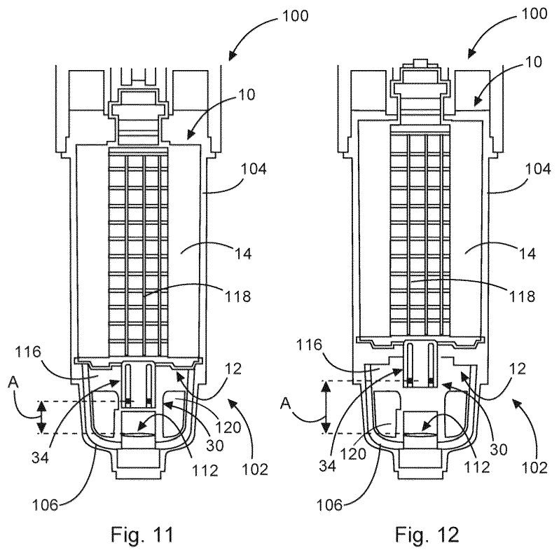

FIG. 11 shows a further exemplary embodiment of the fluid filter according to the invention, in which the filter material of the filter cartridge does not have any contamination, in a schematic sectional view;

FIG. 12 shows the fluid filter depicted in FIG. 11, wherein the filter material of the filter cartridge has severe contamination, in a schematic sectional view;

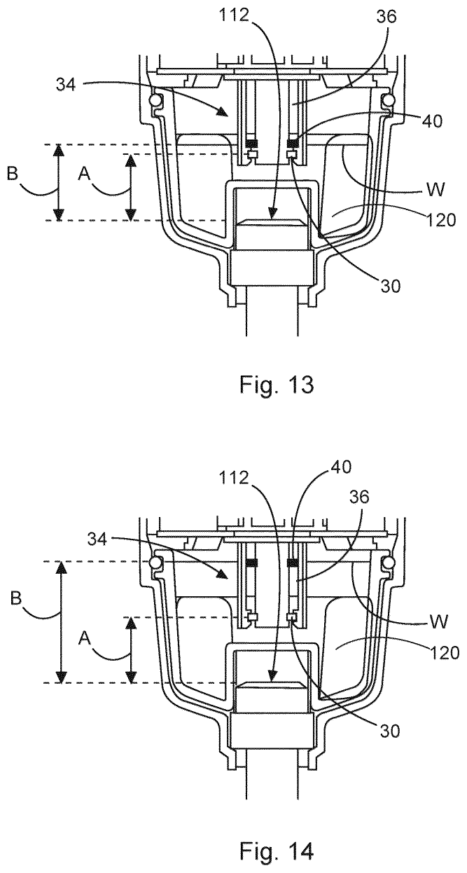

FIG. 13 shows the water collection area of a fluid filter according to the invention at a low water level;

FIG. 14 shows the water collection area shown in FIG. 13, at a high water level;

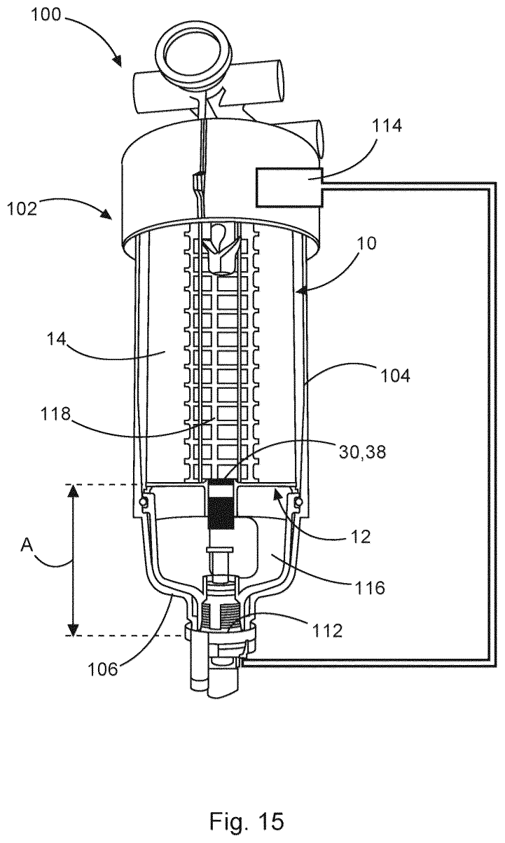

FIG. 15 shows a further exemplary embodiment of the fluid filter according to the invention, in a schematic sectional view;

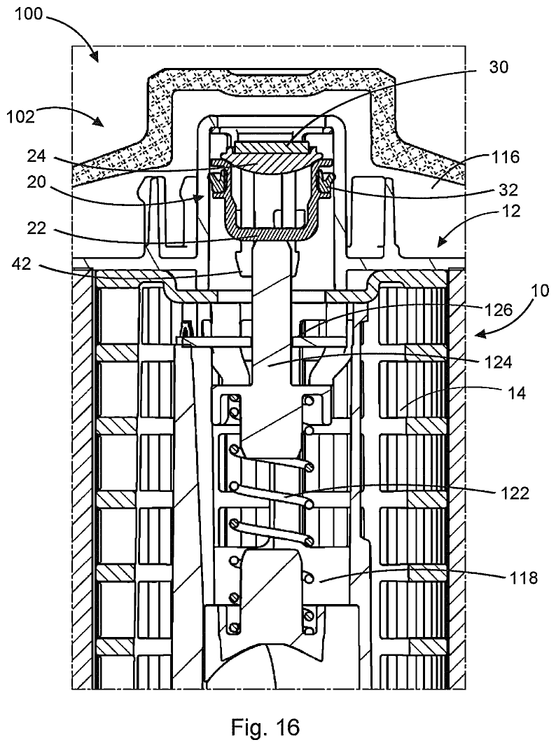

FIG. 16 shows a further exemplary embodiment of the fluid filter according to the invention, in which the filter material of the filter cartridge does not have any contamination;

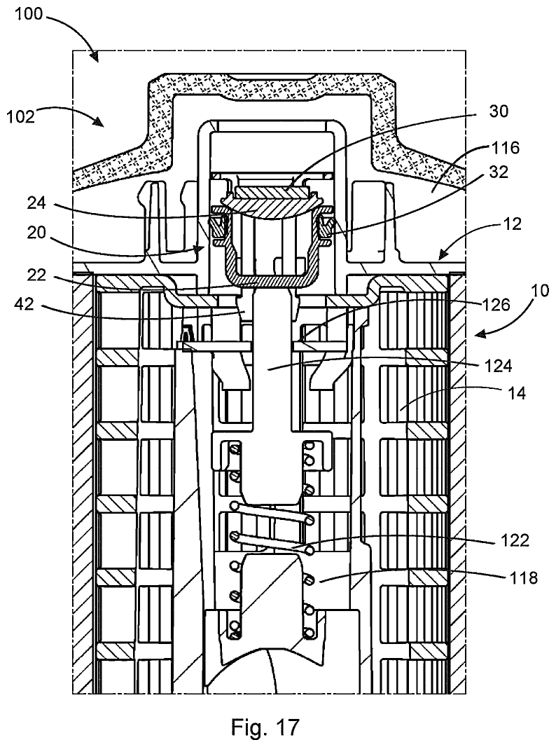

FIG. 17 shows the fluid filter depicted in FIG. 16, wherein the filter material of the filter cartridge has a slight contamination;

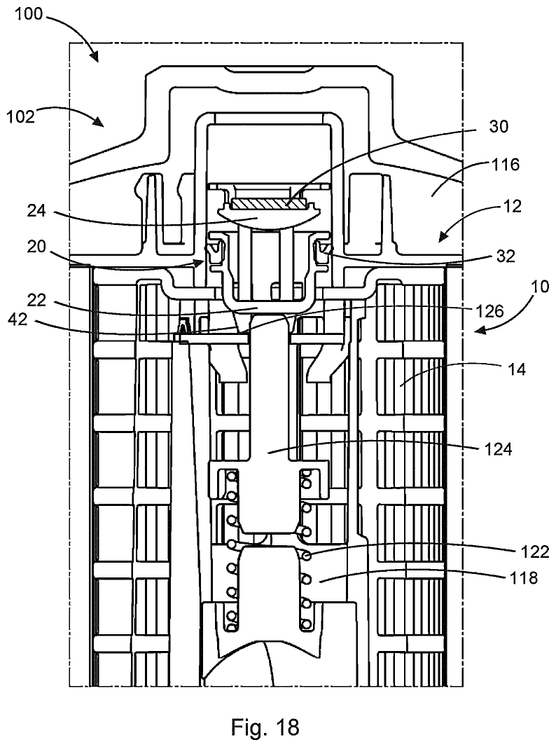

FIG. 18 shows the fluid filter depicted in FIG. 16, wherein the filter material of the filter cartridge has severe contamination; and

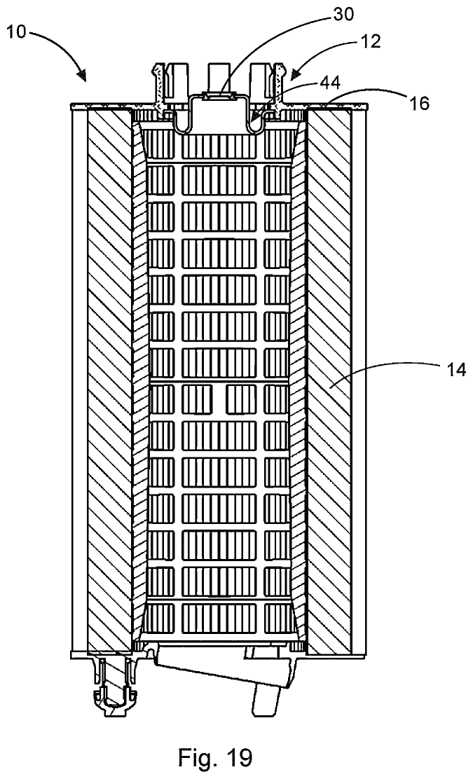

FIG. 19 shows a further exemplary embodiment of the filter cartridge according to the invention, in a schematic sectional view.

FIG. 1 shows a fluid filter 100 designed as an oil filter. The fluid filter 100 comprises a multi-piece filter housing 102, the filter housing 102 having a housing base body 104 and a housing cover 106. The cup-shaped housing cover 106 and the housing base body 104 are screwed together via the thread 108.

In addition, the fluid filter 100 has a supporting mandrel 110 onto which a filter cartridge 10 is placed. By unscrewing the housing cover 106, the filter cartridge 10 can be removed from the filter housing 102 of the fluid filter 100.

The filter element 10 has a circumferential bellows as the filter material 14, wherein the fluid to be filtered flows through the filter material 14 from a raw side 116 to a clean side 118 of the fluid filter 100 during operation of the fluid filter 100. The filter material 14 is supported by a support structure 12. The support structure 12 comprises an end plate 16 which is arranged on a front end of the filter material 14.

Furthermore, the fluid filter 100 comprises a bypass valve 20, via which a bypass line between the raw side 116 and the clean side 118 of the fluid filter 100 can be opened, so that a sufficient fluid flow through the fluid filter 100 is ensured even when there is strong contamination of the filter material 14. With increasing contamination, the closure body 22 of the bypass valve 20 executes an axial movement within a guide sleeve in the direction of the spring 28, the spring 28 working against the axial movement of the closure body 22. As a result of the axial movement of the closure body 22, the distance between the valve seat 26 and the closure body 22 increases as the differential pressure between the raw side 116 and the clean side 118 of the fluid filter 100 increases. The valve seat 26 is a component of the contact body 24, which is an integral component of the end plate 16. With increasing contamination of the filter material 14, the differential pressure between the raw side 116 and the clean side 118 of the fluid filter 100 increases. When this differential pressure exceeds a limit value, the bypass line is opened by the bypass valve 20.

The filter cartridge 10 comprises a filter-cartridge-side radio module 30. The filter-cartridge-side radio module 30 is an RFID transponder and is arranged on the closure body 22 of the bypass valve 20. A housing-side radio module 112 is arranged on the filter housing 102. The housing-side radio module 112 is an RFID reading device. The filter-cartridge-side radio module 30 and the housing-side radio module 112 are designed to communicate with one another. Due to the arrangement of the filter-cartridge-side radio module 30 on the closure body 22 of the bypass valve 20, the filter-cartridge-side radio module 30 moves during operation of the fluid filter 100 as a function of the pressure difference between the raw side 116 and the clean side 118 of the fluid filter 100, which pressure difference is dependent on the contamination state of the filter material 14. As the contamination state of the filter material 14 changes, the distance A between the filter-cartridge-side radio module 30 and the housing-side radio module 112 also changes. The contamination state of the filter material 14 can be detected via the variable distance A between the housing-side radio module 112 and the filter-cartridge-side radio module 30.

To detect the distance A between the filter-cartridge-side radio module 30 and the housing-side radio module 112, the housing-side radio module 112 can be connected to an electronic data processing device which evaluates the signals sent by the filter-cartridge-side radio module 30 to the housing-side radio module 112 and/or the signal properties thereof in order to determine the distance A between the filter-cartridge-side radio module 30 and the housing-side radio module 112. The electronic data processing device is preferably designed to evaluate the signal strength and/or the signal noise of the signals transmitted from the filter-cartridge-side radio module 30 to the housing-side radio module 112 and to determine the distance A between the radio modules 30, 112 on the basis of this evaluation. On the basis of the distance A between the radio modules 30, 112, the electronic data processing device can then determine the contamination state of the filter material 14. The contamination state is determined here, for example, via a filter-specific, filter-cartridge-specific, or filter-material specific relationship between the distance A of the radio modules 30, 112 and the contamination state of the filter material 14.

The filter-cartridge-side radio module 30 is designed to obtain the energy required for communication with the housing-side radio module 112 from an electromagnetic field generated by the housing-side radio module 112. The filter-cartridge-side radio module 30 thus does not require its own power supply.

The filter-cartridge-side radio module 30 is designed to transmit radio signals via which, in addition to the distance A of the filter-cartridge-side radio module 30 from the housing-side radio module 112, further filter-cartridge-specific and fluid-specific parameters can be determined. For example, the filter-cartridge-side radio module 30 can transmit a filter-cartridge-specific identifier, via which the currently used filter cartridge 10 can be identified. During operation of the fluid filter 100, the filter-cartridge-side radio module 30 can detect and record filter-cartridge-related operating information and/or fluid-specific operating information in order to transmit this information to the housing-side radio module 112.

In the state shown in FIG. 1, the filter material 14 of the filter cartridge 10 is uncontaminated, so that there is a comparatively low differential pressure between the raw side 116 and the clean side 118 of the fluid filter 100. The differential pressure is so small that the radially sealing closure body 22 of the bypass valve 20 is still resting on the valve seat 26, against which the closure body 22 is pressed by the spring 28.

In the state shown in FIG. 2, a slight contamination of the filter material 14 has already taken place. The resulting increased differential pressure between the raw side 116 and the clean side 116 of the fluid filter 100 has led to the closure body 22 together with the radio module 30 being pressed downwards against the spring 28. The movement of the closure body 22 is accompanied by an increase in the distance A between the filter-cartridge-side radio module 30 and the housing-side radio module 112. This change in distance can be detected through a signal evaluation of the radio signals transmitted from the filter-cartridge-side radio module 30 to the housing-side radio module 112.

FIG. 3 shows a state in which the filter material 14 of the filter cartridge 10 is severely contaminated. The contamination of the filter material 14 has led to a further increase in the differential pressure between the raw side 116 and the clean side 118 of the fluid filter 100, so that the closure body 22 of the bypass valve 20 has moved further against the spring 28. The distance A between the radio modules 30, 112 has likewise increased accordingly. The differential pressure between the raw side 116 and the clean side 118 of the fluid filter 100 has exceeded a differential pressure limit value, so that a bypass line between the raw side 116 and the clean side 118 has been opened. The bypass line is formed by a plurality of passage openings in the wall surrounding the closure body 22. As soon as the closure body 22 has passed the passage openings, at least a portion of the fluid can pass unfiltered from the raw side 116 to the clean side 118 of the fluid filter 100. The flow through the opened passage openings is indicated in FIG. 3 by a flow arrow. Ideally, filter cartridge 10 should be replaced before reaching the state shown in FIG. 3, so that opening of the bypass line during operation of the fluid filter 100 is avoided.

FIG. 4 shows that snap hooks are arranged on the upper end plate 16 of the support structure 12, via which snap hooks the filter cartridge 10 is clipped into a circumferential groove of the housing cover 106. The snap hooks and the guide sleeve guiding the closure body 22 are integral components of the end plate 16.

FIG. 5 shows an alternative arrangement of the housing-side radio module 112. In this case, the housing-side radio module 112 is arranged on a supporting mandrel 110 of the filter housing 102, wherein the filter cartridge 10 is placed on the supporting mandrel 110.

FIGS. 6 and 7 show exemplary embodiments with a plurality of filter-cartridge-side radio modules 30a-30c. During operation of the fluid filter 100, in order to detect the state of contamination of the filter material 14 the filter-cartridge-side radio modules 30a-30c can move as a function of the pressure difference between the raw side and the clean side of the fluid filter 100 and communicate with a radio module 112 of the housing-side fluid filter 100. The number of filter cartridge-side radio modules 30a-30c communicating with the housing-side radio module 112 is dependent on their axial position and thus on their distance A from the housing-side radio module 112. Via the number of filter-cartridge-side radio modules 30a-30c communicating with the housing-side radio module 112, it is thus possible to determine the distance A between the housing-side radio module 112 and the filter-cartridge-side radio modules 30a-30c, from which a data processing device can then calculate the contamination state of the filter material 14. The filter-cartridge-side radio modules 30a-30c are arranged one above the other.

In the embodiment shown in FIG. 6, the housing-side radio module 112 is arranged on the housing cover 106. If the differential pressure between the raw side 116 and the clean side 118 of the fluid filter 100 increases due to increasing contamination of the filter material 14, a radio module holder 34, which bears the filter-cartridge-side radio modules 30a-30c, will be pushed away from the housing-side radio module 112, so that the distance between the filter-cartridge-side radio modules 30a-30c and the housing-side radio module 112 increases with increasing differential pressure between the raw side 116 and the clean side 118 of the fluid filter 100. In the state shown, the radio module holder 34 together with the radio modules 30a-30c has not yet been pushed away from the housing-side radio module 112, since the filter material 14 is not, or is only slightly, contaminated. The radio module holder 34 moves together with the contact body 24 bearing the valve seat. When there is a differential pressure increase between the raw side 116 and the clean side 118, the contact body 24 and closure body 22 of the bypass valve 20 at first move together in the axial direction away from the housing-side radio module 112. During this movement, the filter-cartridge-side radio module 30c first leaves the reception range of the housing-side radio module 112. A further increase in differential pressure between the raw side 116 and the clean side 118 of the fluid filter 100 results in a further axial movement of the contact body 24 and the closure body 22, causing the filter-cartridge-side radio module 30b and subsequently, possibly, the filter-cartridge-side radio module 30a as well to leave the reception range of the housing-side radio module 112. A data processing device can then determine the contamination state of the filter material 14 via the number of filter-cartridge-side radio modules 30a-30c communicating with the housing-side radio module 112.

Before the bypass valve 20 opens, the contact body 24 bearing the valve seat strikes the stop surface 126, so that when the pressure difference is increased the closure body 22 is moved further away in the axial direction from the housing-side radio module 112 without the contact body 24. The bypass valve 20 is then opened by the relative movement of the closure body 22 and the contact body 24. The closure body 22 is therefore the part of the bypass valve 20 which executes the movement leading to an opening of the bypass valve 20. The contact body 24 bearing the valve seat is the part of the bypass valve 20 which is stationary or does not execute any movement during the opening of the bypass valve 20.

FIG. 7 shows an embodiment in which the housing-side radio module 112 is arranged in a supporting mandrel 110 of the filter housing 102.

FIGS. 8 and 9 show a filter cartridge 10 in which the filter-cartridge-side radio module 30 is not arranged on the closure body 22, but rather on the contact body 24, bearing the valve seat 26, of the bypass valve 20. The closure body 22 is again the part of the bypass valve 20 which executes the movement leading to an opening of the bypass valve 20. The contact body 24 bearing the valve seat is again the part of the bypass valve 20 which is stationary or does not execute any movement during the opening of the bypass valve 20. In the embodiment shown, the closure body 22 and the contact body 24 initially move together when there is an increase in the differential pressure between the raw side 116 and the clean side 118 of the fluid filter 100 before the bypass valve 20 is opened. When there is an increase in the differential pressure between the raw side 116 and the clean side 118 of the fluid filter 100, there will thus also be a movement of the contact body 24 bearing the valve seat 26. Due to the axial movement of the contact body 24, there is a change in distance between the radio module 30 arranged on the contact body 24 and the housing-side radio module 112. In addition, a circumferential seal 32 is arranged on the contact body 24 and ensures a radial seal between the contact body 24 and the sleeve guiding the contact body 24 on the end plate 16.

FIG. 10 shows a variant comparable to the embodiment shown in FIG. 7, wherein the filter cartridge 10 has only one radio module 30 and the housing-side radio module 112 is arranged on a supporting mandrel 110 of the filter housing 102.

In the exemplary embodiment of the fluid filter 100 shown in FIGS. 11 and 12, the entire filter cartridge 10 moves in the axial direction when there is an increase in the differential pressure between the raw side 116 and the clean side 118 of the fluid filter 100. The filter-cartridge-side radio module 30 is arranged in a radio module holder 34 of the filter cartridge 10.

In the state shown in FIG. 11, the distance A between the filter-cartridge-side radio module 30 and the housing-side radio module 112 is comparatively short due to the comparatively low differential pressure between the raw side 116 and the clean side 118 of the fluid filter 100.

FIG. 12 shows a state in which the filter material 14 of the filter cartridge 10 is severely contaminated, so that there is a comparatively high differential pressure between the raw side 116 and the clean side 118 of the fluid filter 100. The high differential pressure between the raw side 116 and the clean side 118 of the fluid filter 100 has resulted in an axial deflection of the filter insert 10, which has also increased the distance A between the filter-cartridge-side radio module 30 and the housing-side radio module 112. The distance A between the radio modules 30, 112 and thus the contamination state of the filter material 14 can be determined through a signal evaluation of the radio signals which have been transmitted from the filter-cartridge-side radio module 30 to the housing-side radio module 112. The signal evaluatation is undertaken by an electronic data processing device.

The fluid filter 100 shown in FIGS. 11 and 12 is a fuel filter whose filter material 14 separates water from the fuel during filtration. The separated water collects in a water collection area 120. FIGS. 13 and 14 show an embodiment with an additional buoyant radio module 40, wherein two different water levels W in the water collection area 120 are shown.

The radio module holder 34 has a floating chamber 36 designed as a floating cage, in which the buoyant radio module 40 is arranged. The floating cage 36 projects into the water collection area 120 of the fluid filter 100 in which water separated from the fluid to be filtered collects during operation of the fluid filter 100. The buoyant radio module 40 floats on the water collecting in the water collection region 120, wherein the floating cage 36 has a buoyancy region for the buoyant radio module 40, which allows the buoyant radio module 40 to rise when the water level W rises in the water collection region 120 of the fluid filter 100. During operation of the fluid filter, the buoyant radio module 40 floats in a boundary layer between the fluid to be filtered on the raw side of the fluid filter 100 and the water quantity located in the water collection area 120 of the fluid filter 100. As the water level W increases, the distance B between the radio modules 40, 112 also increases. The distance B can be determined by a signal evaluation of the radio signals transmitted from the buoyant radio module 40 to the housing-side radio module 112. A data processing device can then determine the water level in the water collection area 120 from the distance B. The contamination state of the filter material 14 can furthermore be determined via the radio module 30 and its distance A from the housing-side radio module 112. The radio module 30 and the radio module 40 are radio modules of different types, which use different types of modulation, so that their radio signals are distinguishable. In addition, the radio signals can be assigned to the radio modules 30, 40 on the basis of a transmitted identifier.

In another embodiment, the same radio module can also be used for water level detection and detection of the contamination state of the filter material 14. By evaluating the change in distance over time, the electronic data processing device making the evaluation can determine in this case whether the change in distance due to an axial movement of the entire filter cartridge has occurred due to an increase in the differential pressure between the raw side 116 and the clean side 118 or due to an increase in the water level W. In this case, via an evaluation of the radio signals it is thus possible to distinguish between a change in distance caused by contamination and a change in distance due to a change in water level.

FIG. 15 shows a fluid filter 100 designed as a fuel filter, in which the filter-cartridge-side radio module 30 has a temperature measuring device 38 and is designed to transmit temperature measurement values to the housing-side radio module 112. The filter-cartridge-side radio module 30 can comprise an additional microcontroller and one or more temperature sensors which form the temperature measuring device 38. The transmitted temperature measurement values can be used for controlling or regulating a heating device 114, the heating device 114 being used to heat the fuel within the filter housing 102. When the fuel temperature is too low, the heating device 114 can be switched on. The one or more temperature sensors of the temperature measuring device 38 can be thermistors, for example hot conductors. In the exemplary embodiment shown in FIG. 15, the distance A between the filter-cartridge-side radio module 30 and the housing-side radio module 112, and thus the contamination state of the filter material 14, can moreover be determined via a data processing device.

FIGS. 16 to 18 show a fluid filter 100 with a bypass valve 20. The bypass valve 20 comprises a contact body 24 bearing the valve seat and a closure body 22 on which a radially sealing and circumferential seal 32 is arranged. The closure body 22 is the part of the bypass valve 20 which executes the movement leading to an opening of the bypass valve 20. The contact body 24 bearing the valve seat is the part of the bypass valve 20 which is stationary or does not execute any movement during the opening of the bypass valve 20. A filter-cartridge-side radio module 30 is arranged on the contact body 24.

A spring 122 acts on the closure body 22 via the intermediate member 124. In the state shown in FIG. 16, the filter material 14 is not contaminated, so that the differential pressure between the raw side 116 and the clean side 118 of the fluid filter 100 is so small that the spring 122 presses the closure body 22, together with the contact body 24 and the radio module 30, maximally upward.

FIG. 17 shows a state in which the filter material 14 is contaminated more severely, so that the differential pressure between the raw side 116 and the clean side 118 of the fluid filter 100 ensures that the closure body 22 together with the contact body 24 and the radio module 30 are moved axially. In this way, when there is an increase in the differential pressure between the raw side 116 and the clean side 118 of the fluid filter 100, the distance of the filter-cartridge-side radio module 30 from a housing-side radio module (not shown) changes.

When there is a further increase in the differential pressure between the raw side 116 and the clean side 118 of the fluid filter 100, the stop body 42 connected to the contact body 24 strikes the stop surface 126, so that a further axial movement of the contact body 24 and of the filter-cartridge-side radio module 30 is prevented. Due to the fact that the closure body 22 executes a further axial movement as the filter material 14 becomes progressively contaminated and the differential pressure between the raw side 116 and the clean side 118 of the fluid filter 100 increases as a result, the bypass valve 20 is opened.

The opened bypass valve 20 is shown in FIG. 18. The filter-cartridge-side radio module 30 that allows the detection of the contamination is consequently arranged on the part of the bypass valve 20 which is stationary, i.e. does not carry out any movement, during the opening of the bypass valve 20.

In the filter cartridge 10 shown in FIG. 19, the filter-cartridge-side radio module 30 is fastened to an elastomer bellows 44. The elastomer bellows 44 is connected to the support structure 12 of the filter cartridge 10. The filter cartridge 10 can be used, for example, with the filter housing 102 shown in FIGS. 16 to 18, so that when there is an increasing differential pressure between the raw side 116 and the clean side 118 of the fluid filter 100 the filter-cartridge-side radio module 30 presses against the intermediate member 124. Thus, as the differential pressure between the raw side 116 and the clean side 118 of the fluid filter 100 increases, the elastomer bellows 44 deforms, and there is simultaneously an axial movement of the filter-cartridge-side radio module 30.

### LIST OF REFERENCE SIGNS

10 Filter cartridge
12 Support structure
14 Filter material
16 End plate
20 Bypass valve
22 Closure body
24 Contact body
26 Valve seat
28 Spring
30, 30a, 30c Radio modules
32 Seal
34 Radio module holder
36 Floating chamber
38 Temperature measuring device
40 Radio module
42 Stop body
44 Elastomer bellows
100 Fluid filter
102 Filter housing
104 Housing base body
106 Housing cover
108 Thread
110 Supporting mandrel
112 Radio module
114 Heating device
116 Raw side
118 Clean side
120 Water collection area
122 Spring
124 Intermediate member
126 Stop surface
A Distance
B Distance
W Water level

1. A filter cartridge for insertion in a filter housing of a fluid filter, the filter cartridge comprising:
a filter material configured to filter a fluid flowing therethrough from a raw side to a clean side of the fluid filter during operation of the fluid filter; and
a filter-cartridge-side radio module configured to: move, during operation of the fluid filter, as a function of the pressure difference between the raw side and the clean side of the fluid filter, the pressure difference depending on a degree of contamination of the filter material; and communicate, to ascertain the degree of contamination of the filter material, with a housing-side radio module of the fluid filter, a distance to the housing-side radio module from the filter-cartridge-side radio module varying upon movement of the filter-cartridge-side radio module.

2. The filter cartridge according to claim 1,
wherein the filter-cartridge-side radio module is configured to transmit one or more radio signals by means of which a distance to the filter-cartridge-side radio module from the radio housing-side module is determined, or which allows an identification of the filter cartridge or a type recognition of the filter cartridge.

3. The filter cartridge according to claim 1, further comprising:
a bypass valve, or at least a part of the bypass valve, wherein the filter-cartridge-side radio module is arranged on the bypass valve or the filter-cartridge-side part of the bypass valve or is integrated into the bypass valve or the filter-cartridge-side part of the bypass valve.

4. The filter cartridge according to claim 3,
wherein the bypass valve has a movable closure body or the filter-cartridge-side part of the bypass valve comprises the movable closure body, the movable closure body configured to move relative to a contact body, bearing a valve seat, of the bypass valve, as a function of the pressure difference between the raw side and the clean side of the fluid filter, the filter-cartridge-side radio module being arranged on the closure body of the bypass valve, or configured to move together with the closure body of the bypass valve.

5. The filter cartridge according to claim 4,
wherein the closure body is arranged in a guide sleeve configured to guide the closure body during a movement caused by differential pressure.

6. The filter cartridge according to claim 3,
wherein the bypass valve has a movable contact body or the filter-cartridge-side part of the bypass valve comprises the movable contact body, which carries a valve seat for a closure body of the bypass valve, wherein the contact body is configured to move relative to the closure body as a function of the pressure difference between the raw side and the clean side of the fluid filter, the filter-cartridge-side radio module being arranged on the contact body of the bypass valve, or configured to move together with the contact body of the bypass valve.

7. The filter cartridge according to claim 1,
wherein the filter material is supported by a support structure configured to move together with the filter material during operation of the fluid filter as a function of the pressure difference between the raw side and the clean side of the fluid filter, wherein the filter-cartridge-side radio module is arranged on the support structure or the filter material or is configured to move together with one or more of the support structure and the filter material.

8. The filter cartridge according to claim 7,
wherein the support structure has a radio module holder which extends in the axial direction from an end plate of the support structure arranged on the end face of the filter material on a side facing away from the filter material, wherein the filter-cartridge-side radio module is held axially spaced apart from one or more of the end plate and the filter material by the radio module holder.

9. The filter cartridge according to claim 8,
wherein the radio module holder has a floating chamber in which a buoyant radio module is one or more of arranged and configured to project into a water collection area of the fluid filter in which water separated from the fluid to be filtered, collects during operation of the fluid filter.

10. The filter cartridge according to claim 9,
wherein the buoyant radio module is configured to float on the water collecting in the water collection area, wherein the floating chamber has a buoyancy region for the buoyant radio module, which allows the buoyant radio module to rise when a water level rises in the water collection area of the fluid filter.

11. The filter cartridge according to claim 1,
wherein one or more of the filter-cartridge-side radio module and the buoyant radio module are configured to obtain the energy required for the communication with the housing-side radio module from an electromagnetic field generated by the housing-side radio module.

12. The filter cartridge according to claim 1,
wherein one or more of the filter-cartridge-side radio module and the buoyant radio module comprises one or more of a transponder, and an RFID transponder.

13. The filter cartridge according to claim 1,
wherein one or more of the filter-cartridge-side radio module and the buoyant radio module has a temperature measuring device and is configured to transmit temperature measurement values to the housing-side radio module.

14. A fluid filter for filtering a fluid, comprising:
a filter housing having a housing-side radio module; and
a filter cartridge having a filter-cartridge-side radio module, wherein the filter cartridge is configured for insertion in the filter housing;
wherein the filter-cartridge-side radio module and the housing-side radio module are configured to communicate with each other;
wherein the filter cartridge is configured according to claim 1.

15. The fluid filter according to claim 14,
wherein the housing-side radio module is configured to receive one or more radio signals from the filter-cartridge-side radio module, by means of which a distance of the filter-cartridge-side radio module from the housing-side radio module is determined.

16. The fluid filter according to claim 14,
wherein:
the filter housing has a housing base body and a housing cover, the housing-side radio module being arranged in or on the housing base body or the housing cover; or
the filter housing has a supporting mandrel for the filter cartridge, the housing-side radio module being arranged on or in the supporting mandrel.

17. The fluid filter according to claim 14, further comprising:
a water drainage valve for draining the water which collects in a water collection area of the fluid filter, wherein the water drainage valve is configured to be actuated as a function of a distance between the buoyant radio module and the housing-side radio module (112).

18. A filter system, comprising
a fluid filter; and
an electronic data processing device,
wherein the fluid filter is configured according to claim 14, and
wherein the electronic data processing device is configured to evaluate at least one of: one or more signals transmitted from the filter-cartridge-side radio module to the housing-side radio module; and the signal properties of the one or more signals to determine a distance between the filter-cartridge-side radio module (30, 30a-30c) and the housing-side radio module.

19. The filter system according to claim 18,
wherein the electronic data processing device is configured to determine the distance between the filter-cartridge-side radio module and the housing-side radio module on the basis of the signal strength and/or the signal noise of the one or more signals.

20. The filter system according to claim 18,
wherein the electronic data processing device is configured to determine the contamination state of the filter material on the basis of the distance between the filter-cartridge-side radio module and the housing-side radio module.
